(19) United States
(12) Patent Application Publication
(10) Pub. No.: US 2008/0244645 A1
(43) Pub. Date: Oct. 2, 2008

(54) METHOD AND SYSTEM FOR PRESENTING AN UPDATEABLE NON-LINEAR CONTENT LINEUP DISPLAY

(75) Inventors: Hannah Y. Moon, Boston, MA (US); D. Beau Morley, Somerville, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Laboratories Inc., Waltham, MA (US)

(21) Appl. No.: 11/694,924

(22) Filed: Mar. 30, 2007

(51) Int. Cl. G06F 3/00

(52) U.S. Cl. 725/37

(57) ABSTRACT

A method and system may include sending a linear content signal to cause display of linear content, receiving a graphical user interface display request signal requesting display of a graphical user interface, and sending a graphical user interface signal to cause display of a graphical user interface, which is associated with a non-linear content identifier field, which is associated with a non-linear content identifier.

### BACKGROUND INFORMATION

One difficulty with advertising in television broadcasts is that only a limited number of television programs are available in a limited number of time slots. Because of these limitations, advertising in television broadcasts can be expensive. Even if advertising space is purchased, the duration of the longest advertisement spots are usually no more than 30 seconds. Additionally, few metrics are available to provide advertisers with meaningful feedback on who is actually watching their commercials or television advertisements. The metrics that can be gathered from broadcast television are limited in scope. These limited metrics for mass media often may cause advertisers to miss the mark when an advertiser desires to provided targeted advertising.

Another difficulty with advertising in television broadcasts is that consumers often are not paying attention to the advertisement because there are too many advertisements and/or most advertisements are not relevant to the consumer. Many consumers have adopted advertisement-avoidance tactics to reduce their commercial viewing. Because of innovations like digital video recorders, consumers are increasingly skipping over advertisements.

Problems also exist with advanced television advertising models. Under most advanced television advertising models, a viewer is required to respond (by hitting a button on a remote, for example) to notifications and/or bugs that are displayed during a television advertisement to instantiate an advanced advertisement. These notification and bugs often are only displayed momentarily during television advertisements, but are removed when the television programming starts again. This gives the viewer only a short window of opportunity to access the advanced advertisement.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 illustrates a system that may present an updateable non-linear content display to permit a viewer to identify non-linear content in accordance with exemplary embodiments of the present disclosure;

FIG. 2 illustrates an Interactive Program Guide (IPG) server in accordance with exemplary embodiments of the present disclosure;

FIG. 3 illustrates linear content being displayed to a viewer at a display device in accordance with exemplary embodiments of the present disclosure;

FIG. 4 illustrates a content guide display in accordance with exemplary embodiments of the present disclosure;

FIG. 5 illustrates a content information bar in accordance with exemplary embodiments of the present disclosure;

FIG. 6 illustrates a recorded linear content display in accordance with exemplary embodiments of the present disclosure;

FIG. 7 illustrates an updateable non-linear content lineup display in accordance with exemplary embodiments of the present disclosure;

FIG. 8 illustrates an updateable non-linear content lineup display, after selection of a non-linear content identifier field, displaying additional subtopic non-linear content identifier fields in a subdisplay in accordance with exemplary embodiments of the present disclosure;

FIG. 9 illustrates an updateable non-linear content lineup display in accordance with exemplary embodiments of the present disclosure;

FIG. 10 illustrates an updateable non-linear content lineup display displaying non-linear video content in accordance with exemplary embodiments of the present disclosure;

FIG. 11 illustrates an updateable non-linear content lineup display displaying non-linear textual content in accordance with exemplary embodiments of the present disclosure;

FIG. 12 illustrates a flow diagram of a method in accordance with exemplary embodiments of the present disclosure; and

FIG. 13 illustrates an input device in accordance with exemplary embodiments of the present disclosure.

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

A system and method in accordance with exemplary embodiments of the present disclosure may include sending a linear content signal to cause display of linear content. The system and method may further include receiving a graphical user interface display request signal requesting display of a graphical user interface. The system and method also may include sending a graphical user interface signal to cause display of a graphical user interface, which is associated with a non-linear content identifier field, which is associated with a non-linear content identifier.

The description below describes servers, computers, terminals, client devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, terminals, client devices, etc.) separately. The functions described as being performed at various components may be performed at other components, and the various components may be combined and/or separated. Other modifications also may be made.

A system in accordance with exemplary embodiments of the present disclosure may present to a viewer an updateable non-linear content lineup display associated with linear content the viewer is watching. The updateable non-linear content lineup display may be a graphical user interface that allows a viewer to retrieve non-linear content associated with the linear content. Content may refer to multimedia that uses, for example, one or more of text, audio, graphics, video, and/or combinations thereof. Generally, content may be divided into two categories: linear content and non-linear content. Linear Content may refer to content that is displayable in a predefined sequence, which is determined before a broadcast time of the content. An example of linear content is a television program having commercial advertisements inserted therein in a defined sequence before the program is broadcast. Non-linear content may refer to content, which is associated with linear content, that involves viewer interaction to access during or after a display of the linear content. The non-linear content may include, for example, audio, video, music, photos, banners, a webpage, recipes, instructions, etc.

The system implementing the updateable non-linear content lineup display may have both a front-end component (e.g., client device) and a backend component (e.g., server). The front-end component may provide an interface that notifies a viewer of available non-linear content associated with the linear content (e.g., a single television asset (program)) and allows the viewer to navigate to non-linear content of interest. The non-linear content may be stored on the back-end component. While viewing linear content, the system in accordance with exemplary embodiments of the present disclosure may present the updateable non-linear content lineup display to a viewer at a display device. The updateable non-linear content lineup display may include a list of non-linear content identifier fields associated with the linear content that may be used to retrieve non-linear content of interest to the viewer. The non-linear content identifier fields may allow the front-end component to access the non-linear content to allow playback of the non-linear content during the scheduled broadcast time of the linear content, during a Video on Demand (VoD) session, after the linear content has been stored to a digital video recorder (DVR), My TV or the Market Place. The non-linear content identifier fields may be associated with non-linear content identifiers (e.g., Uniform Resource Locators (URLs), other pathways, etc.), which may be used to retrieve non-linear content via a data communication session with the back-end component.

The non-linear content may be indefinitely accessible for viewing and may be updated over time. Because the non-linear content may be associated with the updateable advertising display and may be discretely stored, the system can offer longer run times for the non-linear content, a variety of formats for the non-linear content (e.g., video, interactive, banner etc.), associations of the non-linear content with multiple linear content, and the capability to update the non-linear content over time. Thus, the system in accordance with exemplary embodiments of the present disclosure may retrieve non-linear content that is current as of the time the viewer watches the linear content, instead of only being current at the time the linear content is recorded. This may permit the viewer to view the linear content at a time of his or her choosing, and to indefinitely access updated and relevant non-linear content. The linear content provider may use the advanced non-linear content lineup in conjunction with traditional advertisements included in the linear content to increase advertisement sales and to better target the advertising audience. In addition, the system in accordance with exemplary embodiments of the present disclosure may permit a viewer to opt-in to view non-linear content (e.g., advertisement). Viewers are more likely to retain advertisements that they choose to watch, when they want to watch the advertisement, for products and/or services that they engage in and are of interest to the viewers.

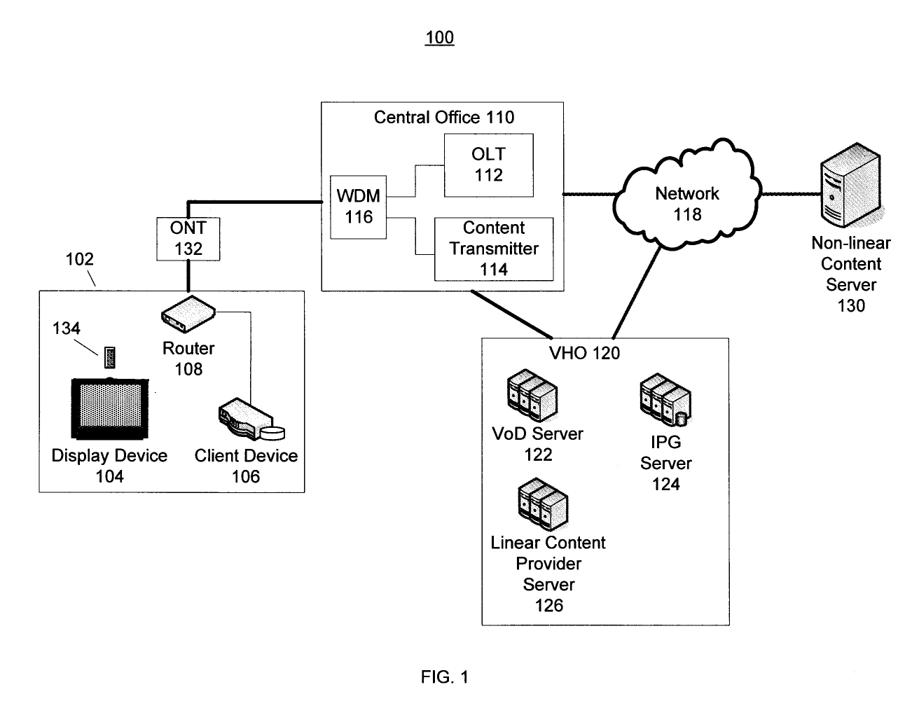

FIG. 1 illustrates a system that may present an updateable non-linear content display to permit a viewer to identify non-linear content in accordance with exemplary embodiments of the present disclosure. The system 100 is exemplary, and generally any system where a client device 106 may receive broadcast linear content from a linear content provider over a communication network and may exchange digital data to request and receive non-linear content may be used. The system 100 also may be implemented for use by a cable provider, a satellite provider, an Internet provider, a radio provider, a telecommunications provider, or other providers that distribute content to client devices 106. The system 100 is a simplified figure, other components can be included. The system 100 may include a subscriber location 102, an optical network termination (ONT) 132, a central office 110, a network 118, a video head office (VHO) 120, and a non-linear content server 130. The video head office (VHO) 120 may communicate linear content signals to the subscriber location 102 via the central office 110.

A client device 106 at the subscriber location 102 may cause a display device 104 to display the received linear content signals representing linear content. The client device 106 may be a digital video recorder, a set top box, a converter, or other device capable of receiving and providing a content signal to cause display of linear content and/or non-linear content at a display device 104. The display device 104 may be a television set, for example. The display device 104 also may be other devices capable for displaying video, such as, but not limited to, a computer monitor. The client device 106 and the display device 104 also may be a single device, instead of two separate devices, as shown.

The linear content signals received from the video head office (VHO) 120 may be cable television signals and the viewer may select a channel for viewing a particular television program, for example. The video head office (VHO) 120 may include a Video on Demand (VoD) Server 122, a Interactive Program Guide (IPG) server 124, and a linear content provider server 126. The Video on Demand (VoD) Server 122 may permit a viewer to select non-linear content for viewing at a time of the viewer's choice. The Interactive Program Guide (IPG) server 124 may provide guide data useable in a content guide for displaying the available content during a particular time slot. The linear content provider server 126 may generate the linear content signals useable to display the linear content at a display device 104.

The non-linear content server 130, the Interactive Program Guide (IPG) server 124, and the central office 110 may communicate with one another via the network 118. The network 118 may be a wired network and/or a wireless network, and may communicate using known protocols, such as, but not limited to, circuit-switched protocols (e.g. asynchronous transfer mode (ATM), etc.) and/or packet switched protocols (e.g., Internet Protocol (IP), etc.). Other protocols also may be used and conversions between one or more protocols may occur, both of which are well known.

The non-linear content server 130 may provide an interface for content providers to accept bids and non-linear content from one or more advertisers. The non-linear content server 130 may communicate the non-linear content to the client device 106 for display to the viewer, as described in further detail below. The non-linear content server 130 may store non-linear content, as well as non-linear content identifiers and linear content identifiers to map and/or associate the non-linear content to the linear content.

Each content identifier (non-linear and linear) may be, for example, a letter sequence, a number sequence, a symbol sequence, other information useable to uniquely identify content, and/or combinations thereof. The linear content identifier may be assigned by a broadcaster to distinguish linear content from other linear content. For example, the linear content identifier may be a number and letter sequence “XR234CWB—Episode 27” unique to this television program. The non-linear content server 130 may assign non-linear content identifiers to the uploaded non-linear content. For example, the non-linear content identifier may be a number and letter sequence “MRXE93—advertisement 77” unique to an advertisement.

The non-linear content server 130 may be, for example, an Intranet Web Server having an Advertisement Server Interface. The non-linear content server 130 may implement a Pay Per Click (PPC) Advertising model where advertisers may be charged when a viewer selects to view the non-linear content. In an exemplary embodiment, the non-linear content server 130 may permit advertisers to place bids to have non-linear content associated with linear content being broadcast by the linear content provider server 126. For example, the advertiser may bid to have their non-linear content, which may be a video advertisement, associated with a particular television program. The advertisers also may submit expiration information for the non-linear content. The expiration information may be a time, a date, a time period (e.g., 30 days), or other information permitting the advertiser to indicate when to make the non-linear content unavailable for sending to client devices 106. For example, the advertiser may upload non-linear content to promote a holiday sale, and after the holiday, the advertiser may indicate not to use the non-linear content. In another example, the expiration may be used to replace the current non-linear content with updated non-linear content of a different advertisement (e.g., post holiday sale).

The one or more advertisers with the highest bid or bids may have a non-linear content identifier field appear in an updateable non-linear content lineup display presented to the viewer via the client device 106, as discussed in further detail below. The non-linear content server 130 may specify a minimum bid amount for display in a non-linear content identifier field of the updateable non-linear content lineup display, or may display non-linear content identifier fields for all bids received from the advertiser. To provide the non-linear content identifier field in the updateable non-linear content lineup display, in addition to submitting a bid, the advertiser may upload non-linear content to the non-linear content server 130 for storage and/or may include a link (e.g., Uniform Resource locator) to the non-linear content.

Once the bid is received and the non-linear content is uploaded, the non-linear content server 130 may associate the uploaded non-linear content with a linear content identifier of the linear content the advertiser has bid on. The linear content identifier may be used to uniquely identify the linear content. For example, each linear content may have a unique linear content identifier. Linear content identifiers may be assigned to linear content. The non-linear content may be, for example, video, audio, text, interactive advertisements, Video on Demand (VoD), long advertisements, banner advertisements, program guide, advertisement, interactive advertising, program information, etc., for advertising a product or service. For example, an advertiser, who has purchased a television commercial for a particular program, also may desire to provide a non-linear content advertisement that contains a website of the advertiser. In a further example, a car company may purchase a linear 30 second advertisement segment in a particular television program, and also may purchase a non-linear content advertisement for a 15 minute video for a particular new car model. By storing the non-linear content discretely, with a linear content identifier (e.g., pointer) to the linear content it is associated with, the non-linear content can be updated indefinitely, even after the linear content has been broadcast. For example, the advertiser may upload a new non-linear content (e.g., a new video) to advertise a new promotion. Permitting updating of the non-linear content increases the shelf life and extensibility of the non-linear content even if a viewer decides to record linear content and not watch the linear content until a later time.

The non-linear content server 130 also may permit advertisers to provide targeting of viewers. The non-linear content server 130 may have the capability to serve targeted non-linear content to various viewers. For example, an advertiser may upload different versions of the same non-linear content and/or different non-linear content. Based on targeting rules, the non-linear content server 130 may serve the different versions of the same non-linear content to different viewers or may serve different non-linear content to different viewers. The targeting rules may be based on a locale of the Video Head Office (VHO) 120, a zip code, a neighborhood, a city, a county, a state, a country, demographics, psychographics, or other rules to target different types of viewers. The demographic and psychographic information for targeting may come from third parties aggregators, such as, but not limited to, Experian Corporation or Axciom Corporation. A non-linear content identifier request, as discussed further below, sent from the client device 106 may include information on the locale of the client device 106 and/or on the viewer for the targeting rules. Also, the viewer may obtain a user profile and may login to the client device 106. The user profile may include information, such as, but not limited to, a first and last name of a viewer, a telephone number, a street address, or other information that may identify one or more members associated with the subscriber location. The viewer may opt-in to allow advertisers to have access to some or all of the user profile for targeted marketing purposes.

The non-linear content server 130 may manage conflicts between non-linear content associated with different advertisers. The non-linear content server 130 may permit advertisers to allow or exclude their non-linear content to be shown with non-linear content from other advertisers. The non-linear content server 130 may, for example, ensure that an advertisement for a first advertiser (e.g., first car company) does not appear on the same updateable non-linear content lineup display as a second advertiser (e.g., second car company). The non-linear content server 130 may manage conflicts by notifying advertisers of the other advertisers who may share the same updateable non-linear content lineup display. The non-linear content server 130 also may provide a more sophisticated, intelligent conflict management that can determine conflicts based on information about the non-linear content. For example, the non-linear content server 130 may identify conflicts based on two or more advertisers attempting to upload non-linear content with a same category (e.g., cars). The non-linear content server 130 also may permit an advertiser to pay an increased fee to exclude other advertisers from advertising on the same updateable non-linear content lineup display during a particular linear content broadcast.

It is noted that other revenue models may be used other than a pay per click model based on receiving bids. The revenue model may be similar to conventional television advertising models with rates for presenting non-linear content of advertisers being set based on a time of day, ratings of a linear content (e.g., television ratings), availability of avails, and/or other metrics associated with television advertising. An avail may refer to an advertising spots available to a linear content provider to insert local advertising. Also, advertisers may be charged according to a pricing formula based on a percentage used of a screen of the display device 104.

The non-linear content server 130 may communicate an advertisement message to inform the Interactive Program Guide (IPG) server 124 about the uploaded non-linear content. The advertisement message may include a linear content identifier of the linear content the advertiser has bid on, and a non-linear content identifier to identify the non-linear content uploaded by the advertiser. The non-linear content identifier may uniquely identify each non-linear content. The non-linear content identifier may be used to retrieve the associated non-linear content from the non-linear content server 130.

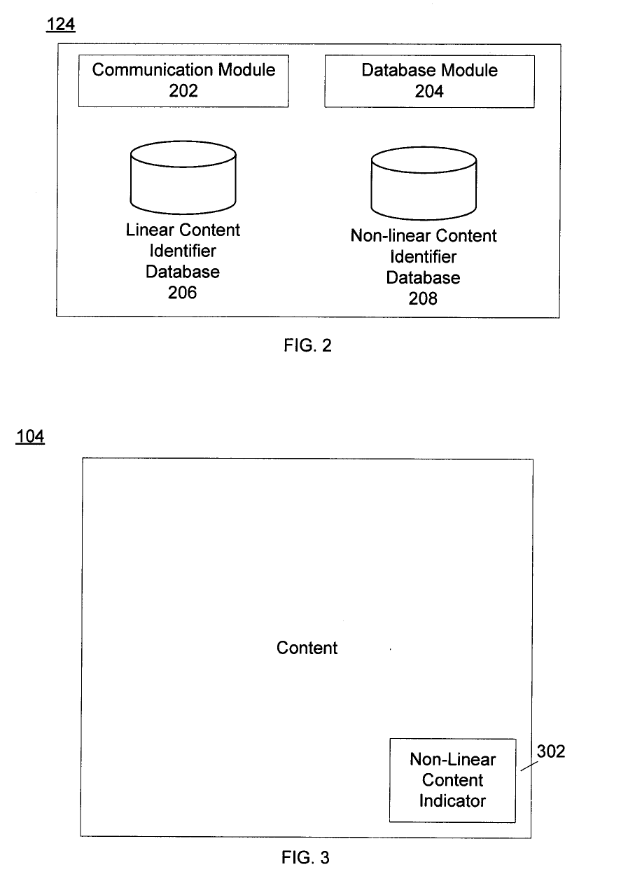

FIG. 2 illustrates an Interactive Program Guide (IPG) server in accordance with exemplary embodiments of the present disclosure. The Interactive Program Guide (IPG) server 124 may provide guide data for use in a graphical user interface displayed at the display device 104 to permit the viewer to identify and select desired linear content for viewing. Some or all of the data stored at and/or some or all of the functions performed by the Interactive Program Guide (IPG) server 124, as described herein, also may occur at other devices (not shown) coupled to the network 118 instead of or in addition to the Interactive Program Guide (IPG) server 124. The Interactive Program Guide (IPG) server 124 also may forward non-linear content identifiers for use in notifying the viewer about non-linear content associated with a particular linear content. The Interactive Program Guide (IPG) server 124 may forward the non-linear content identifiers along with the linear content signals, or the client device 106, when a viewer selects to view a particular linear content, may forward a non-linear content identifier request that includes a linear content identifier of the selected linear content. The Interactive Program Guide (IPG) server 124 may then return any non-linear content identifiers associated with the linear content identifier.

The Interactive Program Guide (IPG) server 124 may include a communication module 202, a database module 204, a linear content identifier database 206, and a non-linear content identifier database 208. The communication module 202 may communicate content signals to the central office 110 and may receive digital data via the network 118. The communication module 202 may forward the received digital data signals to the database module 204.

The database module 204 may access and store data in the linear content identifier database 206 and in the non-linear content identifier database 208. The linear content identifier database 206 may store linear content identifiers that the client device 106 may use to create a linear content guide for display at the display device 104. The non-linear content identifier database 208 may store, in the non-linear content server 130, non-linear content identifiers and linear content identifiers associated with the non-linear content identifiers. The Interactive Program Guide (IPG) server 124 may communicate the linear content identifiers and the non-linear content identifiers associated with the linear content identifiers to the client device 106. The client device 106 may receive various types of information, linear content, and non-linear content through the central office 110.

Referring again to FIG. 1, the central office 110 may communicate optical signals to the optical networking termination (ONT) 132. The optical signals may be used to transport digital data and/or video, for example. The central office 110 may include a wave-division multiplexer (WDM) 116 to combine signals received from the video head office (VHO) 120 and from the network 118 for transport to the optical networking termination (ONT) 132. In various exemplary embodiments, the central office 110 may communicate using a passive optical network. Other networks instead of or in addition to a passive optical network also may be used. The passive optical network may, for example, comply with the International Telecommunication Union Telecommunication Standard (ITU-T) Recommendation G.983.1 titled “Broadband Optical Access Systems based on Passive Optical Networks (PON),” January 2005, the contents of which are incorporated herein by reference in its entirety. Downstream digital data optical signals transmitted from the wavelength division multiplexer (WDM) 116 to the optical networking termination (ONT) 132 may use a 1490 nanometer (nm) wavelength. A radio frequency optical video signal transmitted from the wavelength division multiplexer (WDM) 116 to the optical networking termination (ONT) 132 may use a 1550 nanometer (nm) wavelength. Upstream digital data optical signals transmitted from the optical networking termination (ONT) 132 to the wavelength division multiplexer (WDM) 116 may use a 1310 nanometer (nm) wavelength. The radio frequency optical video signal may comply with the American National Standard Society of Cable Telecommunication Engineers standard ANSI/SCTE 07 2006 titled “Digital Transmission Standard for Cable Television,” the contents of which are incorporated herein by reference in its entirety. Other optical and non-optical communication systems, networks, and standards also may be used.

The wavelength division multiplexer (WDM) 116 may multiplex the downstream digital data optical signals from the optical line terminal (OLT) 112 with the radio frequency video signal from the content transmitter 114 for transmission to the optical networking termination (ONT) 132. The optical line terminal (OLT) 112 may communicate digital data to and from the network 118. The wavelength division multiplexer (WDM) 116 may wavelength division multiplex the 1490 nanometer (nm) wavelength of the downstream digital data optical signals and the 1550 nanometer (nm) wavelength of the radio frequency optical video signal for transmission to the optical networking termination (ONT) 132. The wavelength division multiplexer (WDM) 116 also may demultiplex the 1310 nanometer (nm) wavelength upstream digital data signals received from the optical networking termination (ONT) 132 and may forward the upstream digital data signals to the video head office (VHO) 120 and/or to the network 118. The optical networking termination (ONT) 132 may convert the radio frequency optical video signal and the downstream digital data optical signals to electrical radio frequency signals for transmission via coaxial wiring of the subscriber location 102. A router 108 at the subscriber location 102 may receive and forward the electrical radio frequency signals to a client device 106. For example, the client device 106 may be coupled to an Ethernet port of the router 108. Optionally, the router 108 may be omitted and the client device 106 may be connected to the optical networking termination (ONT) 132 and a multimedia over coaxial (MOCA) cable technology may be used for data communication. The client device 106 may process and/or convert the electrical radio frequency signals to cause display of linear and/or non-linear content at the display device 104.

The client device 106 may establish a video communication session for receiving linear content and non-linear content from the video head office (VHO) 120 and may establish a data communication session for communicating digital data to request and receive non-linear content from the non-linear content server 130. The video communication session may communicate video linear content signals in an analog and/or digital format. For example, the video communication session may transport radio frequency 64 point signal constellation Quadrature Amplitude Modulation (QAM) digital cable signals, or may transport cable signals in other analog or digital cable television formats, as are well known. The video communication session also may transport packetized video.

The data communication session may be used to communicate digital data, such as packets, cells, or other data types. For example, the data communication session may be an Internet Protocol channel for exchanging Internet Protocol packets. The data communication session may be used to permit the client device 106, the Interactive Program Guide (IPG) server 124, and the non-linear content server 130, to communicate non-linear content, as will be discussed in further detail below. The data communication session may make it possible for non-linear content (e.g., advanced advertising) to run continuously in conjunction with a broadcast stream of the linear content. By using the data communication session, the client device 106 may indefinitely store non-linear content identifiers. Thus, the client device 106 may use the non-linear content identifiers to request retrieval of non-linear content during or after the broadcast of the associated linear content, thereby permitting viewers to receive updated non-linear content no matter when the viewer decides to actually watch the linear content. The viewer may, using an input device 134, select to view particular linear content by communicating an output signal to the client device 106 to select linear content broadcast by the video head office (VHO) 120.

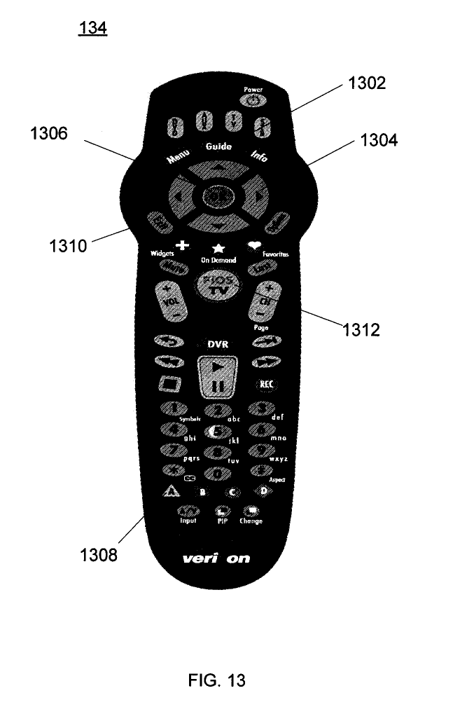

FIG. 13 illustrates an input device in accordance with exemplary embodiments of the present disclosure. The input device 134 may receive inputs from a viewer to instruct the client device 106 to perform various functions. The commands on the input device 134 may be, for example, an exit key 1310, a display graphical user interface key 1312, one or more navigation key 1304, a selection key 1306, etc. The exit key 1310 may instruct the client device 106 to exit out of a display of a graphical user interface, the display graphical user interface key 1312 may instruct the client device 106 to cause the display of a graphical user interface (e.g. to display available non-linear content), the one or more navigation keys 1304 may be arrow keys for scrolling through and highlighting various fields of a graphical user interface, and the selection key 1306 may select a particular field within the graphical user interface. It is noted that the input device 134 is depicted as being a remote control with keys that may be pressed by a user. The input device 134 also may include a touchscreen where the viewer may touch an icon on a display. Other input devices also may be used. Depressing one or more of the keys may instruct the input device 134 to generate an output signal encoded with the associated command.

FIGS. 3-11 illustrate various displays presented to the viewer at the display device 104 for identifying and optionally selecting non-linear content for display in accordance with exemplary embodiments of the present disclosure. FIG. 3 illustrates linear content being displayed to a viewer at the display device in accordance with exemplary embodiments of the present disclosure. The display device 104 may display linear and non-linear content, which may be, for example, a television program, a live television broadcast, a recorded broadcast, text, audio, etc. When a viewer selects to view a particular linear content (e.g., selects a particular channel broadcasting the linear content), the client device 106 may identify any non-linear content identifiers associated with the selected linear content based on the guide data of the Interactive Program Guide (IPG) server 124 accompanying the linear content signal. If any non-linear content identifiers are available, the client device 106 may cause the display device 104 to display a non-linear content indicator 302. For example, the client device 106 may cause the display device 104 to overlay the non-linear content indicator 302 over the linear content being displayed. The non-linear content indicator 302 may be a visual indicator indicating to the viewer that non-linear content is available for the selected linear content. Also, the non-linear content indicator 302 may not be displayed and instead a viewer may use the input device 134 to have the client device 106 indicate whether any non-linear content is available for the displayed linear content. For example, the display graphical user interface key 1312 may instruct the client device 106 to cause the display of a graphical user interface (e.g. to display available non-linear content). If non-linear content is not available, the client device 106 may produce an output signal to cause the display device 104 to display an icon and/or other audible and/or visual indicator to indicate to the viewer that no non-linear content is available for the linear content. If non-linear content is available, the client device 106 may produce an output signal to cause the display device 104 to display an icon and/or other audible and/or or visual indicator to indicate that non-linear content is available. The non-linear content indicator 302 also may appear in a content guide display.

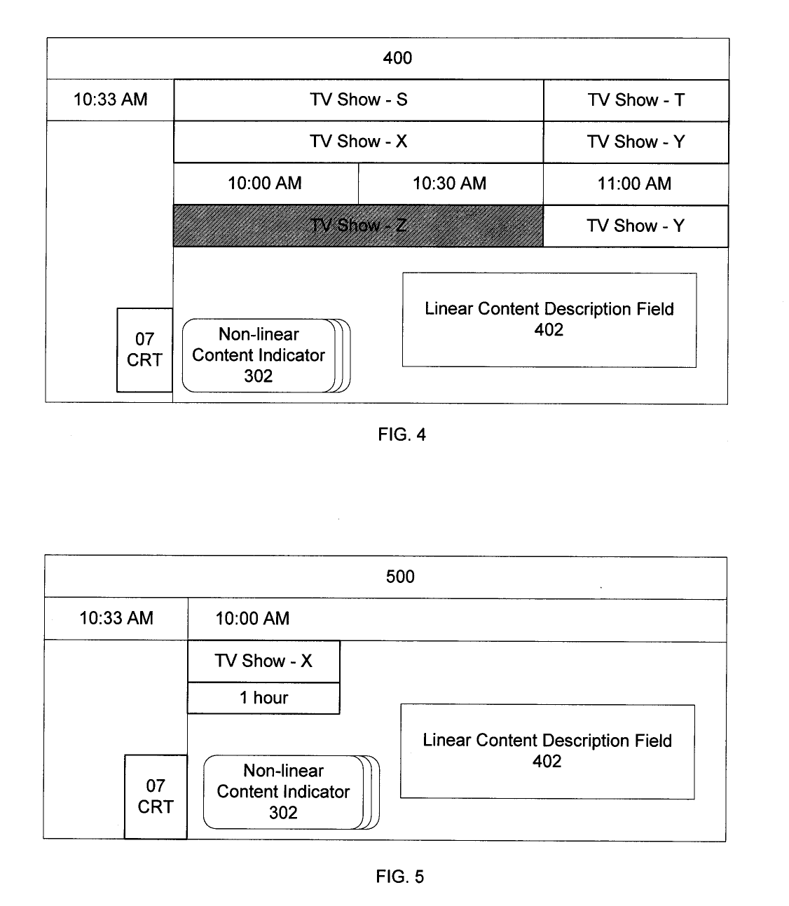

FIG. 4 illustrates a content guide display in accordance with exemplary embodiments of the present disclosure. The content guide display 400 may be a graphical user interface that lists the different linear content being broadcast in a particular time slot. For example, the content guide display 400 may list television shows being broadcast by name in a spreadsheet display. The content guide display 400 may display to the viewer various information associated with the linear content. The content guide display 400 may display a current time, a start time of the linear content broadcast, call letters of the content provider broadcasting the linear content, a channel of the broadcast, a name of the linear content, a length of the linear content broadcast, etc. Other information also may be included. For example, the current time may be 10:33 AM, the start time may be 10:00 AM, the call letters of the broadcaster may be “CRT,” the channel of the broadcast may be “7,” the name of the content may be “TV Show-X,” and the length of the content broadcast may be one hour.

Using the input device 134, the viewer may scroll through the content guide display 400 to select a particular linear content to view a content description field 402. The content description field 402 may include a brief description of the linear content. The content description field 402 may display, for example, a brief synopsis of the linear content, a host of the linear content, any guests appearing on the linear content, a rating (e.g., Parental Guidance) of the linear content, or other information to describe the linear content. For example, the content description field 402 may display “Sally and Ed interview musical recording artist Bob Jones, TV-G.” In a further example, the content description field 402 may display “Environment conducive to losing weight; health and nutrition; instilling good eating habits in children.” The non-linear content indicator 302 may appear in the content guide display 400 if non-linear content is available for the selected linear content. The non-linear content indicator 302 also may appear in a content information bar overlayed at the display device 104 over the content.

FIG. 5 illustrates a content information bar in accordance with exemplary embodiments of the present disclosure. The client device 106 may cause the display device 104 to overlay the content information bar 500 over the linear content being displayed. The content information bar 500 may include the content description field 402, as described above. The non-linear content indicator 302 may appear in the content information bar 500 if non-linear content is available for the selected linear content. The non-linear content indicator 302 also may appear in a recorded linear content display that displays linear content previously recorded by the client device 106.

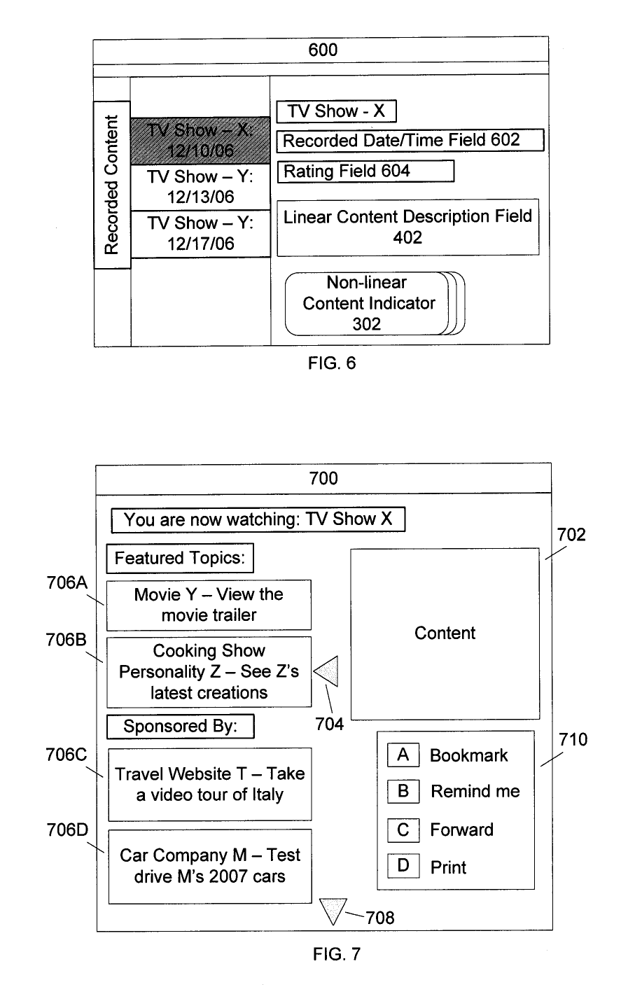

FIG. 6 illustrates a recorded linear content display in accordance with exemplary embodiments of the present disclosure. The recorded linear content display 600 may display one or more recordings of linear content stored at the client device 106. For example, the client device 106 may be a digital video recorder that has recorded multiple television programs. The recorded content display 600 may include a recorded date/time field 602 indicating when the client device 106 recorded the linear content, and a rating field 604 to display a rating of the linear content. The recorded linear content display 600 may include the content description field 402, as described above. The non-linear content indicator 302 optionally may appear in the recorded linear content display 600 if non-linear content is available for the selected linear content.

To generate the recorded linear content display 600, the client device 106 may store at least a linear content identifier in a local database. The local database also may store any non-linear content identifiers associated with the stored linear content identifiers. The client device 106 may use the stored non-linear content identifiers to generate non-linear content identifier fields in an updateable non-linear content lineup display to inform the viewer about available non-linear content, as discussed in further detail below. To access non-linear content, the viewer may, using the input device 134, generate a display graphical user interface display request to request that the client device 106 cause the display device 104 to display an updateable non-linear content identifier field display.

FIG. 7 illustrates an updateable non-linear content lineup display in accordance with exemplary embodiments of the present disclosure. The updateable non-linear content lineup display 700 may be a graphical user interface that displays available non-linear content to the viewer. The updateable non-linear content lineup display 700 may make the non-linear content accessible during and after the broadcast of the linear content via the data communication session, which prevents the viewer from missing the opportunity to access the non-linear content, even if they get up to use the bathroom or fast-forward using a digital video recorder. This contrasts with conventional systems where non-linear content is accessible only for a short duration of time because the non-linear content in conventional systems is distributed via the same linear video stream as the linear content broadcast. The updateable non-linear content lineup display 700 may provide the viewer with access to all of the non-linear content (e.g., advanced advertisements) associated with the linear content.

When the updateable non-linear content lineup display 700 is generated, the client device 106 may resize the linear content that was previously being displayed at the display device 104 in a smaller viewing window 702 so that the viewer may continue to view the linear content. The updateable non-linear content lineup display 700 may display various information, such as, but not limited to, a current time, a date, a broadcast beginning and ending time of a particular linear content, a title of the content, or other information useable to describe the linear content. For example, the updateable non-linear content lineup display 700 may include the title: “You are watching: TV Show X.”

The updateable non-linear content lineup display 700 may include one or more non-linear content identifier fields 706 that are viewer selectable to retrieve non-linear content. The non-linear content identifier fields 706 may include text, graphics, audio, video, or other information to inform the viewer about the non-linear content. For example, a non-linear content identifier field 706 may be a banner advertisement. The non-linear content identifier fields 706 may be associated with non-linear content identifiers, which the client device 106 may use to request the non-linear content associated with the non-linear content identifiers. The viewer may use the input device 134 to navigate through the various non-linear content identifier fields 706. The updateable non-linear content lineup display 700 may include a scroll bar 708 to permit the viewer, using the input device 134, to scroll through the non-linear content identifier fields 706.

The non-linear content identifier fields 706 may correspond to non-linear content uploaded by an advertiser (e.g., an advertisement), and also may correspond to non-linear content uploaded by a content provider (e.g., website associated with the linear content). In an exemplary embodiment, the non-linear content identifier fields 706 may be associated with featured topics of the linear content provider and/or with non-linear content associated with advertisers of the linear content. The featured topics may include additional information about the linear content being viewed by the viewer. The non-linear content identifier field 706 may be used to retrieve non-linear content associated with the linear content, such as, but not limited to, a recipe that is being used in the linear content, a library related videos, biographies of actors/actresses, products, services, other information related to the linear content, and/or combinations thereof. For example, the featured topics may include non-linear content that provides additional information about a music artist appearing on a talk show.

Also, if the viewer is watching recorded linear content, selection of one of the non-linear content identifier field 706 may permit the viewer to jump to a particular segment within the content. In an exemplary embodiment, the client device 106 may store time stamps representing where the different segments occur within the content, and selection of one of the non-linear content identifier field 706 may instruct the client device 106 to cause the display device 104 to display the content beginning at the time stamp. For example, a cooking program may include 3 segments where a chef prepares 3 different recipes. The non-linear content identifier fields 706 each may be associated with a different segment, and selecting one of the non-linear content identifier field 706 may permit the viewer to jump to the segment within the recorded content of the chef preparing the desired recipe.

The non-linear content identifier fields 706 associated with advertisers may direct the viewer to non-linear content that may include advertisements. The order in which the non-linear content identifier fields 706 associated with the advertisers are displayed in the updateable non-linear content lineup display 700 may be ranked based on the bid amount submitted by the advertisers. For example, the updateable non-linear content lineup display 700 may include a “Movie Y—View the movie trailer” 706A, a “Cooking Show Personality Z—See Z's latest creations” 706B, “Travel Website T—Take a video tour of Italy” 706C, and “Car Company M—Test drive M's 2007 cars” 706D.

Upon selection of a non-linear content identifier field 706 by the viewer, the client device 106 may generate a non-linear content request to retrieve non-linear content from the non-linear content server 130 or from the Video on Demand (VoD) server 122, as discussed above. For example, the non-linear content request may be a hypertext transfer protocol (HTTP) request. In addition to retrieving the non-linear content, the updateable non-linear content lineup display 700 may include a command field 710 to instruct the client device 106 to perform functions other than retrieving the non-linear content.

The command field 710 may be a soft key control panel displayed in the updateable non-linear content lineup display 700. The viewer may, for example, use an input key 1308 (e.g., A, B, C, D, etc.) on the input device 134 to select the appropriate command from the command field 710. Upon navigating to a particular non-linear content identifier fields 706, the viewer may depress one of the soft key buttons 1308 on the input device 134 to generate an output signal encoded with a selection request signal including the associated command from the command field 710. The command field 710 may permit the viewer, using the input device 134, to bookmark non-linear content, to set a reminder to retrieve non-linear content at a later time, to forward non-linear content to another client device, and/or to print non-linear content.

In response to the bookmark command, the client device 106 may store a non-linear content identifier associated with the selected non-linear content identifier field 706. The client device 106 may use the stored non-linear content identifier to retrieve the non-linear content from the non-linear content server 130 at a later time or may retrieve the non-linear content for local storage. For example, the client device 106 may store a long advertisement to a favorites list where the viewer can later retrieve and watch the advertisement. The client device 106 may immediately retrieve and store the non-linear content, or instead may store the non-linear content identifier to retrieve the non-linear content at a later time.

In response to the remind command, the client device 106 may store a non-linear content identifier associated with the selected non-linear content identifier field 706. The client device 106 may cause the display device 104 to display a reminder time prompt for the viewer to select a reminder time when to be reminded. The reminder time may instruct the client device 106 when to the display device 104 to display a visual reminder to remind the viewer about the stored non-linear content identifier. The visual reminder also may be appear once an end of a particular linear content is reached. For example, once a television program ends, the client device 106 may cause the display device 104 to display a visual reminder. The viewer may define or set up preferences for when the visual reminders are displayed. The viewer may, for example, select to have the visual reminder displayed the next time they turn on their display device 104 (e.g., next time they turn on their television), once a day, or at other times or time intervals.

In response to the forward command, the client device 106 may forward the non-linear content identifier to another client device local or remote to the subscriber location 102. The client device 106 may send a message (e.g., an email, etc.) containing the non-linear content identifier to the other client device to permit the other client device to retrieve the forwarded non-linear content identifier. For example, a viewer may identify an advertisement of interest to a friend, and may instruct the client device 106 to forward the advertisement to the friend's client device at a different subscriber location.

In response to the print command, the client device 106 may retrieve the non-linear content and may send a print command to an attached or network printer to print a screen shoot of the non-linear content.

The viewer, using the input device 134, may highlight and generate a selection request to select a non-linear content identifier field 706. The updateable non-linear content lineup display 700 may include a visual indicator 704 to indicate which non-linear content identifier field 706 is being highlighted. Other manners of highlighting a non-linear content identifier field 706 also may be used. Once a non-linear content identifier field 706 has been selected, the client device 106 may determine whether to retrieve non-linear content or to display one or more additional non-linear content identifier fields.

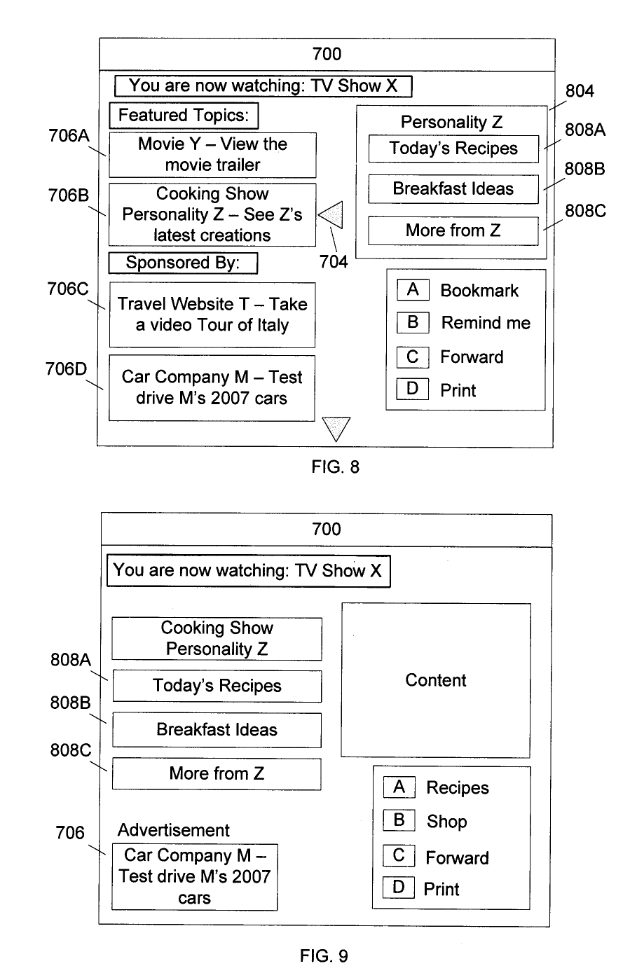

FIG. 8 illustrates an updateable non-linear content lineup display, after selection of a non-linear content identifier field, displaying additional subtopic non-linear content identifier fields in a subdisplay in accordance with exemplary embodiments of the present disclosure. The non-linear content identifier field 706 may be associated with a broader topic, and selection of the non-linear content identifier field 706 may permit the viewer to access (e.g., drill down) to narrower subtopics associated with the broader topic. The narrower subtopics may be presented one or more subtopic non-linear content identifier fields 808 of a subdisplay 804 that appears in the updateable non-linear content lineup display 700. The information presented in the one or more subtopic non-linear content identifier fields 808 may be stored locally at the client device 106 based on the guide data, or may be retrieved remotely from the Interactive Program Guide (IPG) server 124.

The subtopic non-linear content identifier fields 808 may be associated with subtopics within the broader topic of the non-linear content identifier fields 706. For example, selection of a non-linear content identifier field 706 for a Cooking Show Personality Z may retrieve a “Today's Recipes” non-linear content identifier field 808A, a “Breakfast Ideas” non-linear content identifier field 808B, and a “More from Z” non-linear content identifier field 808C. Each of the non-linear content identifier fields 808A-C may be associated with a non-linear content identifier that may be used to retrieve non-linear content, or may be used to drill down to further subtopic non-linear content identifier fields. Instead of displaying the subdisplay 804 within the viewing window 702, selection of a non-linear content identifier field 706 or of a subtopic non-linear content identifier field 808 also may instruct the client device 106 to display subtopics in the updateable non-linear content lineup display 700.

FIG. 9 illustrates an updateable non-linear content lineup display in accordance with exemplary embodiments of the present disclosure. The updateable non-linear content lineup display 700 may display a title of the selected non-linear content identifier field 706 or of the selected subtopic non-linear content identifier field 808 from the previous display. For example, the title may be “Cooking Show Personality Z.” The subtopic non-linear content identifier field 808 may permit the viewer to retrieve non-linear content associated with the linear content the viewer is currently watching. The subtopic non-linear content identifier field 808 may be the same as those fields included in the subdisplay 804. The updateable subtopic non-linear content identifier field display 700 also may display additional non-linear content identifier fields 706 associated with the previously selected non-linear content identifier field 706 (i.e., from FIG. 7).

Once a particular non-linear content identifier field 706 is highlighted, the viewer may press a selection key 1306 to communicate to the client device 106 an output signal encoded with a selection request for selecting a particular non-linear content identifier field 706 and/or a subtopic non-linear content identifier field 808 associated with a non-linear content identifier. Selection of the desired non-linear content identifier field 706 and/or subtopic non-linear content identifier field 808 may instruct the client device 106 to generate a non-linear content request to retrieve the selected non-linear content for display at the display device 104. The client device 106 may first determine whether the selected non-linear content is stored locally. If not stored locally, the client device 106 may communicate the non-linear content request via the data communication session. For example, the client device 106 may communicate the non-linear content request to the non-linear content server 130 or the video on demand (VoD) server 122 to retrieve the selected non-linear content. For example, the client device 106 may communicate with the non-linear content server 130 or the video on demand (VoD) server 122 via an Internet Protocol channel. The non-linear content request may include the non-linear content identifier associated with the selected non-linear content identifier field 706 or the selected subtopic non-linear content identifier field 808.

Upon receipt of the non-linear content request, the non-linear content server 130 or the video on demand (VoD) server 122 may retrieve the non-linear content associated with the non-linear content identifier and may identify the expiration information of the non-linear content. If the non-linear content has not yet expired, the non-linear content server 130 or the video on demand (VoD) server 122 may forward the non-linear content to the client device. The non-linear content server 130 or the video on demand (VoD) server 122 may then send to the client device 106 via the data communication session a non-linear content response that includes the requested non-linear content. If the non-linear content has expired, the non-linear content server 130 or the video on demand (VoD) server 122 may determine if the advertiser has uploaded any updated non-linear content. If uploaded, the non-linear content server 130 or the video on demand (VoD) server 122 may send a non-linear content response including the updated non-linear content. Otherwise, the non-linear content server 130 or the video on demand (VoD) server 122 may send in the non-linear content response: other non-linear content associated with the advertiser; an indication to inform the viewer that the non-linear content has expired; the expired non-linear content. When the non-linear content response is received, the client device 106 may process the non-linear content included in the non-linear content response for display at the display device 104.

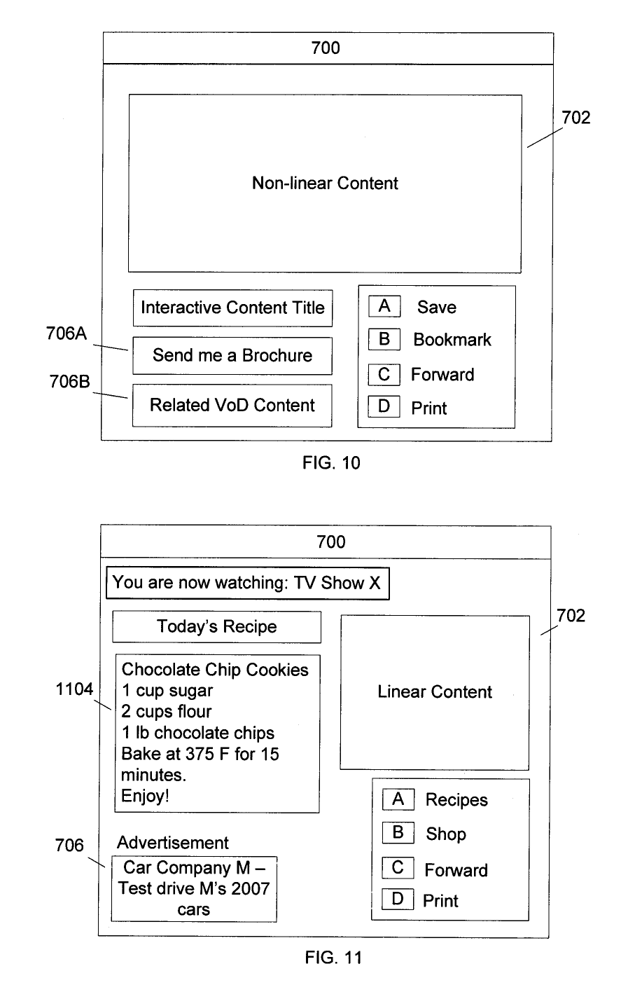

FIG. 10 illustrates an updateable non-linear content lineup display displaying non-linear video content in accordance with exemplary embodiments of the present disclosure. Once the non-linear content response is received including non-linear video content, the client device 106 may cause display of the non-linear video content at the display device 104 in the viewing window 702 of the updateable non-linear content lineup display 700. The non-linear video content also may be displayed full screen. The viewer additionally may toggle between a full screen view and displaying the non-linear content within the viewing window 702. The non-linear video content may be, for example, non-linear video content received from the video on demand (VoD) server 122. The updateable non-linear content lineup display 700 may display a title of the non-linear content to the viewer.

In addition to displaying the non-linear video content, the updateable non-linear content lineup display 700 may include one or more non-linear content identifier fields 706 associated with the non-linear video content. The one or more non-linear content identifier fields 706 may permit the viewer to receive additional information related to the non-linear content being displayed in the updateable non-linear content lineup display 700 and/or other advertisers may have submitted bids to have non-linear content identifier fields 706 associated with the non-linear video content. Thus, the viewer may drill down to locate subtopics or to identify additional non-linear content. For example, selection of the non-linear content identifier field 706A may instruct the client device 106 to send a message to the non-linear content server 130 to mail the viewer a brochure about the product being advertised. The interactive video content display 700 also may include a related non-linear content identifier field 706B. Selection of the related non-linear content identifier field 706B may retrieve additional information that is related to the non-linear video content. For example, the additional information may be about similar products and/or services from an advertiser. The non-linear content response also may include non-linear textual content for display to the viewer along with the linear content.

FIG. 11 illustrates an updateable non-linear content lineup display displaying non-linear textual content in accordance with exemplary embodiments of the present disclosure. The updateable non-linear content lineup display 700 may display a title for the non-linear textual content, and may display the non-linear textual content in a text viewing window 1104. The updateable non-linear content lineup display 700 also may include a non-linear content identifier field 706 for additional non-linear content, such as, but not limited to, a non-linear content advertisement. Both the text viewing window 1104 and the viewing window 702 may be displayed simultaneously, or one or the other may be displayed full screen. The viewer also may toggle between displaying the content, the text, or both. For example, the updateable non-linear content lineup display 700 may display a cooking television program in the viewing window 702 along with a recipe being used on the program in the text viewing window 1104. Also, the non-linear content identifier fields 706 associated with advertisers may be included. In another example, the non-linear content identifier field 706 may be used to navigate to a particular segment within the linear content.

The updateable non-linear content lineup display 700 also may include different commands in the command field 710. The command field 710 may update when the viewer causes the client device 106 to present a new display. For example, the command field 710 may permit the viewer to use the soft keys 1308 to retrieve additional recipes, shop, forward, and print.

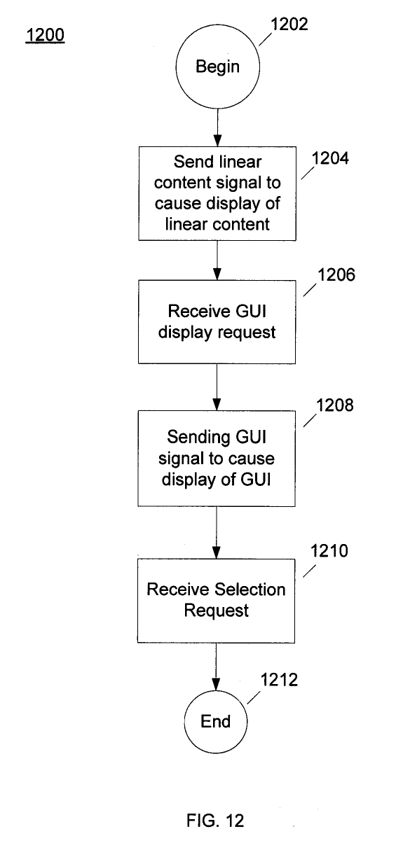

FIG. 12 illustrates a flow diagram of a method in accordance with exemplary embodiments of the present disclosure. This exemplary method 1200 is provided by way of example, as there are a variety of ways to carry out methods according to the present disclosure. The method 1200 shown in FIG. 12 can be executed or otherwise performed by one or a combination of various systems. The method 1200 is described below as carried out by the system 100 shown in FIG. 1 by way of example, and various elements of the system 100 are referenced in explaining the example method of FIG. 12. Each block shown in FIG. 12 represents one or more processes, methods, or subroutines carried in the exemplary method. Referring to FIG. 12, in block 1202, the exemplary method 1200 begins and may continue to block 1204.

In block 1204, the method may include sending a linear content signal to cause display of linear content. In an exemplary embodiment, the client device 106 may receive a linear content signal from the video head office (VHO) 120. The client device 106 may process the linear content signal to cause the display device 104 to display the linear content. The method 1200 may continue to block 1206.

In block 1206, the method may include receiving a graphical user interface display request requesting display of available non-linear content at the display device. In an exemplary embodiment, the client device 106 may receive a graphical user interface display request in a signal output from input device 134. The graphical user interface display request may request display of the updateable non-linear content lineup display 700 at the display device 104. The updateable non-linear content lineup display 700 may be a graphical user interface that displays available non-linear content associated with the linear content. The method 1200 may continue to block 1208.

In block 1208, the method may include sending a graphical user interface signal useable to cause display of a graphical user interface, which is associated with a non-linear content identifier field, which is associated with a non-linear content identifier. In an exemplary embodiment, the client device 106 may generate and send a graphical user interface signal useable to cause display of the updateable non-linear content lineup display 700 at the display device 104. The updateable non-linear content lineup display 700 may include various non-linear content identifier fields 706 associated with non-linear content identifiers to inform the viewer about available non-linear content. The method 1200 may continue to block 1210.

In 1210, the method may include receiving a selection request signal selecting the non-linear content identifier field, the selection request signal indicating whether to retrieve the non-linear content, using the non-linear content identifier, for display or to store the non-linear content identifier. In an exemplary embodiment, the viewer, using the input device 134, may highlight and may communicate a selection request signal to select one of the non-linear content identifier fields 706. The selection request signal may be encoded to indicate if the viewer desires to retrieve the non-linear content associated with the non-linear content identifier field 706 or to store a non-linear content identifier associated with the non-linear content identifier field 706 so that the client device 106 may use the stored non-linear content identifier to retrieve the associated non-linear content at a later time. The method 1200 may continue to block 1212 and end.

The following describes various examples in accordance with exemplary embodiments of the present disclosure. In an exemplary embodiment, the viewer, using the input device 134, may instruct the client device 106 to cause display of a live broadcast linear content at the display device 104. The client device 106 may process guide data from the Interactive Program Guide (IPG) server 124 and may determine whether any non-linear content associated with the broadcast linear content is available. In this example, non-linear content is available and two non-linear content identifiers are associated with the linear content. The client device 106 may cause the display device 104 to display a non-linear content indicator 302.

Upon seeing the non-linear content indicator 302, the viewer, using the input device 134, may generate a graphical user interface display request signal for communication to the client device 106. The client device 106 may cause the display device 104 to display the available non-linear content in an updateable non-linear content lineup display 700. The client device 106 may resize the linear content and may include the resized linear content in the updateable non-linear content lineup display 700. The updateable non-linear content lineup display 700 may display various non-linear content identifier fields 706 associated with the non-linear content identifiers.

The viewer, using the input device 134, may highlight and may generate a selection request to select one of the non-linear content identifier fields 706. In this example, the selected non-linear content identifier field 706 may be associated with a non-linear content identifier of non-linear content that is a video on demand (VoD) video advertisement for a car company. The selection request may include an indication of whether to retrieve the non-linear content or to store a non-linear content identifier associated with the non-linear content. When storing the non-linear content identifier, the selection request also may request a reminder be displayed at the end of the linear content broadcast to remind the user about the stored non-linear content identifier. In this example, the selection request selects to immediately retrieve and view the non-linear content.

The client device 106 may communicate a non-linear content request including the non-linear content identifier to the video on demand (VoD) server 122 storing the non-linear content. The video on demand (VoD) server 122 may retrieve the non-linear content associated with the non-linear content identifier and may send to the client device 106 a non-linear content response containing the non-linear content. The client device 106 may cause the display device 104 to display the non-linear content (e.g., video) in the updateable non-linear content lineup display 700.

In another exemplary embodiment, the client device 106 may include recording capabilities for recording broadcast linear content. The viewer, using the input device 134, may instruct the client device 106 to record live broadcast linear content that appears before the Columbus Day Holiday. The client device 106 also stores the non-linear content identifiers associated with the linear content from the guide data. Two weeks later, the viewer decides to watch the recorded linear content. While causing the display device 104 to display the recorded linear content, the client device 106 also may cause the display device 104 to display the non-linear content indicator 402. The viewer, using the input device 134, may send a graphical user interface display request signal to the client device 106. The client device 106 may resize the linear content and may include the resized linear content in an updateable non-linear content lineup display 700. The updateable non-linear content lineup display 700 may include various non-linear content identifier fields 706 for display to the viewer based on the one or more non-linear content identifiers associated with the linear content.

The viewer, using the input device 134, may highlight and generate a selection request to select one of the non-linear content identifier fields 706. In this example, the non-linear content identifier field 706 may be associated with a non-linear video content advertisement for a car company stored at the non-linear content server 130. The selection request may indicate whether to retrieve the non-linear content for immediate viewing or to store a non-linear content identifier. The selection request also may be associated with a reminder when storing the non-linear content identifier. The client device 106 may display the reminder at the end of the recorded linear content to remind the viewer about the stored non-linear content identifier. In this example, the selection request selects to immediately retrieve and view the non-linear content.

The client device 106 may communicate a non-linear content request including the non-linear content identifier to the non-linear content server 130 storing the non-linear content. The non-linear content server 130 processes the non-linear content request and determines that the non-linear content associated with the non-linear content identifier has expired between the date of the linear content broadcast and the current date. The non-linear content server 130 then determines if the advertiser has uploaded any updated non-linear content. In this example, the car company now is no longer advertising for the Columbus Day sale, but now has uploaded an advertisement for a Thanksgiving Weekend sale. The non-linear content server 130 then retrieves the updated non-linear content and forwards to the client device 106 the updated non-linear content in a non-linear content response. The client device 106 may receive the non-linear content response and may cause the display device 104 to display the updated non-linear content.

It is noted that the above description has been provided describing the client device 106 being used at a fixed subscriber location 106. The client device 106 also may be used in other systems. In an exemplary embodiment, the client device 106, the display device 104, and the input device 134 may be implemented at a single computing device, which may be, for example, a mobile phone, a mobile computing device, a personal digital assistant, etc. In such an embodiment, the single computing device, instead of communicating with the central office 110, may communicate with wireless network to access the linear content and the non-linear content.

Thus, a system in accordance with the exemplary embodiments described above may permit a viewer to view linear content and to view non-linear content associated with the linear content. The exemplary system may allow viewers to view non-linear content at a time of their choosing. The exemplary system may permit viewers to retrieve the non-linear content during a broadcast of the linear content, immediately after the end of the linear content broadcast, or at a later time of the viewer's choosing.

The exemplary updateable non-linear content lineup may allow the viewer to choose what non-linear content (e.g., advanced advertisements) they want to watch at a time of their choosing, and not just when an advertisement is inserted in a linear content broadcast. The system in accordance with exemplary embodiments of the present disclosure overcomes problems with consumers who are not paying attention to advertisements due to there being too many advertisements and/or to the advertisement not being relevant. Because of innovations like the digital video recorder, consumers are increasingly skipping over advertisements. The updateable non-linear content lineup addresses these issues by providing a mechanism for the viewer to choose when they watch non-linear content. The updateable non-linear content lineup may provide a quick view of what non-linear content is associated with the linear content and allows the user to review the updateable non-linear content lineup at their leisure. The exemplary updateable non-linear content lineup encourages viewer to opt-in to view non-linear content, and reduces the possibilities that a consumer will adopt advertisement avoidance tactics to reduce advertisement overload.

Regardless of when the viewer watches the linear content (i.e., live or recording), the exemplary system may ensure that the viewer is able to watch updated non-linear content. The exemplary system permits advertisers to update non-linear content (e.g., advertisements) if a viewer records broadcast linear content and does not watch the linear content until a later time.

The exemplary system also advantageously meets the needs of advertisers who wish to advertise both linearly and non-linearly. The exemplary system may be used as a selling point to networks and advertisers when negotiating contracts for television service as the provider of the exemplary system allows non-linear content to be updated based on the time the viewers actually watches the linear content.

The updateable non-linear content lineup may be a suitable option for advertisers of all sizes because the advertisements they create are updateable and can be associated with more than one linear content. In 1960, the average US household had access to 5.7 channels. Today, the same home has more than 100 channels to choose from. Advertisers are aware that their audience is more segmented and they cannot exclusively advertise on one prime time channel any more. To appeal to the audience they are trying to reach, the updateable non-linear content lineup may permit advertisers to provide dynamic and extensible non-linear content (e.g., advertisements) on a specific, targeted level. With services like the updateable non-linear content lineup, the content provider can compete with media alternatives like the World Wide Web for advertising dollars by offering advertising avails for smaller budgets.

The updateable non-linear content lineup may facilitate the ability of local and regional advertisers to advertise along with the national advertisers. In particular, this advertising model may appeal to local advertisers with a smaller budget and advertisers who would like to have and advertising campaign that persists in the system and can be updated over time. Non-linear content from smaller regional advertisers can be presented within the updateable non-linear content lineup along with the national advertisers according to a pricing formula based on a percentage used of a screen of the display device 104. Adding more local advertising through the advanced advertising model is a logical match because non-linear content can be targeted to smaller audience and can be less expensive in price.

In the preceding specification, various preferred embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method comprising:
sending a linear content signal to cause display of linear content;
receiving a graphical user interface display request signal requesting display of a graphical user interface; and
sending a graphical user interface signal to cause display of a graphical user interface, which is associated with a non-linear content identifier field, which is associated with a non-linear content identifier.

2. The method of claim 1, further comprising receiving a selection request signal selecting the non-linear content identifier field, the selection request signal indicating one of retrieving non-linear content using the non-linear content identifier for display and storing the non-linear content identifier as a stored non-linear content identifier.

3. The method of claim 1, further comprising:
sending a non-linear content request including the non-linear content identifier;
receiving a non-linear content response including the non-linear content; and
generating a non-linear content display signal to cause display of the non-linear content.

4. The method of claim 1, further comprising storing a reminder associated with the non-linear content.

5. The method of claim 4, further comprising causing display of a reminder display based on the reminder.

6. The method of claim 4, further comprising causing display of a reminder of the non-linear content.

7. The method of claim 1, further comprising
receiving a selection request signal selecting the non-linear content identifier field; and
causing display of a subtopic non-linear content identifier field associated with the selected non-linear content identifier field.

8. The method of claim 7, further wherein the subtopic non-linear content identifier field is displayed in a subdisplay of the graphical user interface.

9. The method of claim 1, further comprising:
receiving a selection request signal selecting the non-linear content identifier field;
identifying a time stamp associated with the non-linear content identifier field; and
causing display of a segment within the linear content associated with the time stamp.

10. The method of claim 1, further comprising:
sending a non-linear content request including the non-linear content identifier;
receiving a non-linear content response comprising updated non-linear content associated with the non-linear content identifier.

11. A computer readable media comprising code to perform the acts of the method of claim 1.

12. A system comprising:
a client device communicatively coupled to a network, the client device to receive linear content signals to cause display of linear content at a display device, to receive a graphical user interface display request signal requesting display of a graphical user interface, and to cause display of the graphical user interface, which is associated with a non-linear content identifier field, which is associated with a non-linear content identifier.

13. The system of claim 12, wherein the client device receives a selection signal selecting the non-linear content identifier field.

14. The system of claim 13, further comprising
a server communicatively coupled to the network, wherein the client device sends to the server a non-linear content request that includes the non-linear content identifier in response to receiving the selection signal.

15. The system of claim 14, wherein the server identifies non-linear content associated with the non-linear content identifier.

16. The system of claim 15, wherein the server sends to the client device via the network a non-linear content response that includes the identified non-linear content.

17. The system of claim 14, wherein the server determines that non-linear content associated with the non-linear content identifier has expired.

18. The system of claim 17, wherein the server identifies whether any updated non-linear content is associated with the non-linear content identifier.

19. The system of claim 18, where in the event that the server identifies updated non-linear content associated with the non-linear content identifier, the server sends to the client device via the network a non-linear content response that includes the updated non-linear content.

20. The system of claim 19, wherein the client device processes the non-linear content response to cause display of the updated non-linear content.

21. An apparatus comprising:
a video module to send a linear content signal to cause display of linear content; and
a graphical user interface module to receive a graphical user interface display request signal requesting display of a graphical user interface, the graphical user interface module to cause display of a graphical user interface, which is associated with a non-linear content identifier field, which is associated with a non-linear content identifier.
